(19) United States
(12) Patent Application Publication
(10) Pub. No.: US 2001/0039656 A1
(43) Pub. Date: Nov. 8, 2001

(54) Broadcast program storing system

(76) Inventors: Atsuyoshi Nakamura, Tokyo (JP); Naoki Abe, Tokyo (JP); Katsuhiro Ochiai, Tokyo (JP); Hiroshi Matoba, Tokyo (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/818,570

(22) Filed: Mar. 28, 2001

(30) Foreign Application Priority Data
Mar. 29, 2000 (JP) 2000-90553

(51) Int. Cl. H04H 9/00; H04N 7/16

(52) U.S. Cl. 725/9

(57) ABSTRACT

A broadcast program storing system, in which a combination of programs to be stored is optimized, and a program set that makes the degree of satisfaction of a user optimal can be stored, is provided. The broadcast program storing system provides a preference learning means that learns the preferences of a user for programs by viewing behavior of the user, a degree of preference predicting means for predicting the degree of preference of the user for each program from information of the program, and a storing planning means, which chooses a combination of programs by solving a temporally expanded knapsack problem that obtains a solution that the sum of the predicted degree of satisfaction in a planned schedule becomes maximal in a storing capacity having a bound when programs to be stored and programs to be deleted are decided. With this structure, a broadcast storing apparatus, in which programs being suitable for the user are automatically stored by using the storing capacity of the broadcast storing apparatus and the stored programs are displayed to the user, can be realized. Further, by utilizing the broadcast program storing system, a data storing apparatus that stores data received from a TV, a radio, or through the Internet, efficiently and automatically, can be realized by using a magnetic tape or a random access recording medium such as a HDD.

### BACKGROUND OF THE INVENTION

The present invention relates to a broadcast program storing system, in particular, in which broadcast programs are automatically stored in an apparatus that stores and reproduces broadcast contents of such as TV programs.

Description of the Related Art

Recently a TV program storing apparatus used a random access recording medium such as a hard disk drive (HDD) has been developed. One of the TV program storing apparatuses has a function that automatically stores TV programs which a user desires to store based on preferences of the user registered beforehand. This apparatus is described in NIKKEI ELECTRONICS 1998.11.30 (no.731), pp. 41-46. And in the Japanese Patent Applications Laid-Open No. HEI 5-2794, HEI 5-62283, HEI 6-124309, HEI 10-164528, HEI 10-243352, and HEI 10-285528, broadcast program storing methods that store broadcast programs chosen from program information by predicting preferences of a user based on the past data viewed by the user are disclosed.

However, at the conventional apparatus and method, at the case that the storing capacity has a bound, an optimal storing combination of broadcast programs to be stored was not studied. Consequently, there is a problem that a program set, which makes the degree of satisfaction of the user optimal, can not be stored.

### SUMMARY OF THE INVENTION

It is therefore an object of the present invention to provide a broadcast program storing system, in particular, in which broadcast programs are automatically stored in an apparatus that stores and reproduces broadcast contents of such as TV programs in high efficiency.

According to a first aspect of the present invention for achieving the object mentioned above, there is provided a broadcast program storing system. The broadcast program storing system provides a preference learning means for learning preferences of a user for programs by viewing behavior of the user, a degree of preference predicting means for predicting the degree of preference of the user for the programs by obtaining program information, and a storing planing means for choosing programs by solving a temporally expanded knapsack problem that obtains a solution in which the sum of predicted degree of satisfaction of the user in a planned schedule becomes maximal within a bound of a recording medium, when programs to be stored and programs to be deleted are decided.

According to a second aspect of the present invention, in the first aspect, the storing planning means makes a storing plan of programs in the future and also makes a plan of the deleting time of stored programs at the same time. And the storing planning means makes the storing plan of the programs by utilizing efficiently a region of the recording medium where a program that the user reserves to record is recorded until right before the program starts. And further, the storing planning means makes the storing plan of the programs by using a two-step-method in which first a program set to be stored at the ending time of the planned schedule is obtained and a program set to be stored at the intermediate time of the planned schedule for storing in the remaining vacant region of the recording medium is added.

According to a third aspect of the present invention, in the second aspect, when the storing planning means makes the storing plan of the programs by using the two-step-method, the program set to be stored at the ending time of the planned schedule is obtained by a dynamic programming in which a solution that makes the sum of the predicted degree of satisfaction of the user maximal is obtained. And at the two-step-method, the program set to be stored at the ending time of the planned schedule is obtained by a greedy method in which a quasioptimal solution of the predicted degree of satisfaction of the user is obtained by choosing a larger predicted degree of satisfaction in a predicted degree of satisfaction by unit storing time and a predicted degree of satisfaction by unit storing time×survival time. And at the two-step-method, the program set to be stored at the intermediate time of the planned schedule for storing in the remaining vacant region of the recording medium is added by the greedy method in which a quasioptimal solution of the predicted degree of satisfaction of the user is obtained by choosing a larger predicted degree of satisfaction in a predicted degree of satisfaction by unit storing time and a predicted degree of satisfaction by unit storing time×survival time.

According to a fourth aspect of the present invention, in the third aspect, when the storing planning means uses the greedy method, the storing plan is made by not only considering the largeness of the predicted degree of satisfaction but also checking whether elements required to record such as tuners are secured or not. And when the storing planning means uses the greedy method, the storing plan is made by that a ratio among viewing minutes of each genre of programs of the user is obtained by the statistics of the past viewing behavior of the user, and a discount rate for part exceeding from the viewing minute ratio of each genre is calculated and the balance among the genres is kept, when the degree of satisfaction at the time that the programs to be stored are chosen one by one is calculated. And the predicted degree of satisfaction is a predicted degree of preference, or the predicted degree of preference×a program length, or the predicted degree of preference×the program length×survival time.

According to a fifth aspect of the present invention, in the first aspect, the degree of preference predicting means and the preference learning means provides a system. And at the system, an electronic text being program information received from broadcasting or telecommunication is transformed into an attribute vector consisting of keywords, a preference function expressing a relation between an estimated degree of preference estimated from viewing behavior of a user and the attribute vector is learned, a preference function value of the attribute vector is made to be a predicted degree of preference for a program to be stored, a virtual specialist that predicts only when a keyword is in the attribute vector for every program, and weighting of the virtual specialist are set, the prediction is implemented by a weighted average prediction of the virtual specialist, and learning is implemented by adjusting the weighting. And at the system, as a predicted value of the virtual specialist corresponding to each keyword, an average value of the estimated degree of preferences of programs having the attribute vector including the keyword, or a Laplace estimation value (accumulated estimated degree of preference+0.5)/(number of appearances+1.0) of the estimated degree of preferences is used, and learning is implemented by that weighting of the virtual specialist of the estimated degree of preference q is multiplied by rq /p+(1−r) (1−q)/(1-p), in this, p is a predicted weighted average of the virtual specialist and r is an estimated degree of preference from actual viewing behavior of a user.

According to a sixth aspect of the present invention, in the first aspect, at the degree of preference predicting means and the preference learning means, a system is used. And the system provides a preference information server via a telecommunication means. And similarity of preferences among users is learned by the estimated degree of preferences of past programs transmitted via the telecommunication means, and a degree of preference of a user to be predicted for a future program to be stored by the user is estimated by using the estimated degree of preferences of the users for programs transmitted already and the similarity between the user to be predicted and the users. And at the system, a virtual specialist and weighting that implement a prediction, only when the estimated degree of preferences of similar users for every similar user of each user is known, are set, prediction is implemented by the weighted average of the prediction of the virtual specialist, learning is implemented by adjusting the weighting, the estimated degree of preference of the similar user is used as the predicted value of the virtual specialist corresponding to each similar user, and learning is implemented by that the weighting of the virtual specialist of the estimated degree of preference q is multiplied by rq/p+(1−r) (1−q)/(1−p), in this, p is a predicted weighted average of the virtual specialist and r is an estimated degree of preference from actual viewing behavior of a user.

According to a seventh aspect of the present invention, in the first aspect, at the degree of preference predicting means, the weighted average of standard deviation of the predicted degree of preference of each virtual specialist is regarded as being uncertainty, and final predicted degree of preference is that constant times of the uncertainty is added to the predicted weighted average of the virtual specialists.

According to an eighth aspect of the present invention, in the first aspect, the broadcast program storing system further provides recompressing means for recompressing stored data of the programs stored once, and compression rate designating means for designating a compression rate for each program when each program is stored.

According to the present invention, the broadcast program storing system provides a preference learning means that learns the preferences of a user for programs by viewing behavior of the user, a degree of preference predicting means for predicting the degree of preference of the user for each program from information of the program, and a storing planning means, which chooses a combination of programs by solving a temporally expanded knapsack problem that obtains a solution that the sum of the predicted degree of satisfaction in a planned schedule becomes maximal in a storing capacity having a bound when programs to be stored and programs to be deleted are decided. With this structure, a broadcast storing apparatus, in which programs being suitable for the user are automatically stored by using the storing capacity of the broadcast storing apparatus and the stored programs are displayed to the user, can be realized. Further, by utilizing the broadcast program storing system, a data storing apparatus that stores data received from a TV, a radio, or through the Internet, efficiently and automatically, can be realized by using a magnetic tape or a random access recording medium such as a HDD.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a structure of an embodiment of a broadcast program storing system of the present invention;

FIG. 2 is a flowchart showing operation of a program information obtaining means at the embodiment of the broadcast program storing system of the present invention;

FIG. 3 is a flowchart showing operation of a storing planning means at the embodiment of the broadcast program storing system of the present invention;

FIG. 4 is a flowchart showing operation of making a program set RL to be stored at the ending time (step 52 in FIG. 3) by a dynamic programming at the storing planning means at the embodiment of the present invention;

FIG. 5 is a flowchart showing operation of making the program set RL to be stored at the ending time (the step 52 in FIG. 3) by a greedy method as an approximate solution at the storing planning means at the embodiment of the present invention;

FIG. 6 is a flowchart showing operation of adding an additional program set RL to be stored at the intermediate time (step 54 in FIG. 3) by the greedy method as an approximate solution at the storing planning means at the embodiment of the present invention;

FIG. 7 is a block diagram showing a structure of a preference learning means and a degree of preference predicting means at the case that a predicted degree of preference is calculated at a preference information server by using a social filtering method at the embodiment of the present invention; and

FIG. 8 is a block diagram showing a structure of the preference learning means and the degree of preference predicting means at the case that both of the predicted degree of preferences by contents and social are calculated at a home server at the embodiment of the present invention.

### DESCRIPTION OF THE PREFERRED EMBODIMENT

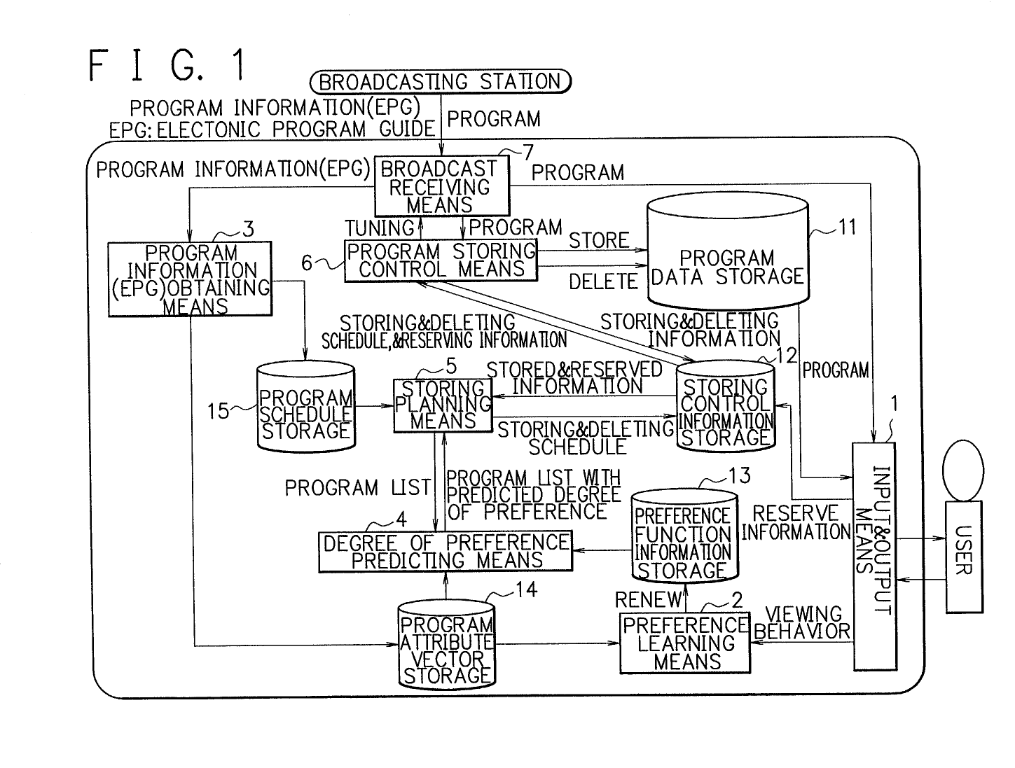

Referring now to the drawings, an embodiment of the present invention is explained in detail. FIG. 1 is a block diagram showing a structure of an embodiment of a broadcast program storing system of the present invention. The embodiment of the broadcast program storing system of the present invention provides an input and output means 1, a preference learning means 2, a program information obtaining means 3, a degree of preference predicting means 4, a storing planning means 5, a program storing control means 6, and a broadcast receiving means 7. And further the embodiment of the broadcast program storing system of the present invention provides program data storage 11 that stores program data, storing control information storage 12 that stores storing control information, preference function information storage 13 that stores preference function information, program attribute vector storage 14 that stores program attribute vectors, and program schedule storage 15 that stores program schedules.

Referring to FIG. 1, operation of the embodiment of the broadcast program storing system of the present invention is explained. First, a user views a program, which a broadcasting station is transmitting and the broadcast receiving means 7 is receiving and is displaying on the input and output means 1 directly, or a program stored in the program data storage 11 by reproducing. And also the user reserves to store programs, which will be broadcast in the future, by using the input and output means 1, at this time, the reserving information is stored in the storage control information storage 12. Further, at this time, the input and output means 1 observes viewing behavior of the user for the program and gives the viewing behavior to the preference learning means 2. In this, the viewing behavior of the user includes behavior such as a reservation of a program, viewing time of a program, deletion of a stored program before viewing, changing a program to permanent saving, and inputting favorite/non-favorite of a program.

The program information obtaining means 3 obtains program information (electronic program guide (EPG)) supplied from the broadcasting station through a broadcast radio wave or from the Internet through the broadcast receiving means 7. And the program information obtaining means 3 gives program attribute vectors, which the program information was transformed into, to the program attribute vector storage 14, and also gives program schedules, which the program information was transformed into, to the program schedule storage 15. The preference learning means 2 learns a preference function that predicts whether the user prefers the program or not from the program attribute, by using the viewing behavior of the user for the program given from the input and output means 1 and the program attribute vectors stored in the program attribute vector storage 14.

The storing planning means 5 obtains information of the stored programs and reserved programs from the storing control information storage 12, and obtains information of programs, which will be broadcast until a designated time in the future, from the program schedule storage 15. And the storing planning means 5 makes a storing and deleting schedule of the programs and gives the schedule to the storing control information storage 12. When the storing planning means 5 makes the storing and deleting schedule, the storing planning means 5 gives a program list to the degree of preference predicting means 4. The degree of preference predicting means 4 obtains the information of the program attribute vectors from the program attribute vector storage 14 and the preference function information from the preference function information storage 13. And the degree of preference predicting means 4 predicts the degree of preference of the programs in the list and returns a program list with the degree of preference to the storing planning means 5.

The storing planning means 5 makes a schedule so that the degree of satisfaction to be predicted of the user is made to be as large as possible, by considering vacant storage capacity, the degree of preference to be predicted, broadcasting time and minutes, the time when the user views, and so on. The program storing control means 6 obtains a storing and deleting schedule and reserving information from the storing control information storage 12, and stores or deletes programs based on the obtained schedule and information. When the storing schedule and the reserving information exist, the program storing control means 6 instructs the broadcast receiving means 7 to tune the channel at the time when the program starts to broadcast and makes the program receive and makes the received program store in program data storage 11.

The programs are stored in a magnetic tape as analog data, or in a random access recording medium such as a magnetic tape, and a HDD as digital data. And at the ending time of the program, the program storing control means 6 makes the broadcast receiving means 7 stop receiving the program, and makes the program data storage 11 stop storing the program. When a deleting schedule exists, the program storing control means 6 gives permission to the program data storage 11 so that a new program is overwritten on a region of the recording medium where the program to be deleted is recorded, at the time when the new program to be stored is scheduled. The program storing control means 6 stores the program data in the program data storage 11 by compressing the program data, in order to utilize efficiently the recording medium whose capacity have a bound.

At this time, a compression rate designating means, which can designate a compression rate for each of programs to be stored by a user, can be added to the structure of the embodiment of the present invention. This compression rate designating means makes the compression rate low for a program whose image quality can not be made to be low, and makes the compression rate high for a program whose broadcasting minutes are long. Further, a recompressing means, which makes the compression rate high in the passage of time, can be added to the structure of the embodiment of the present invention, in order to utilize the region occupied by the programs, which were stored in the recording medium and not viewed for a long time.

Next, the program information obtaining means 3, the storing planning means 5, the degree of preference predicting means 4, and the preference learning means 2 are explained in more detail.

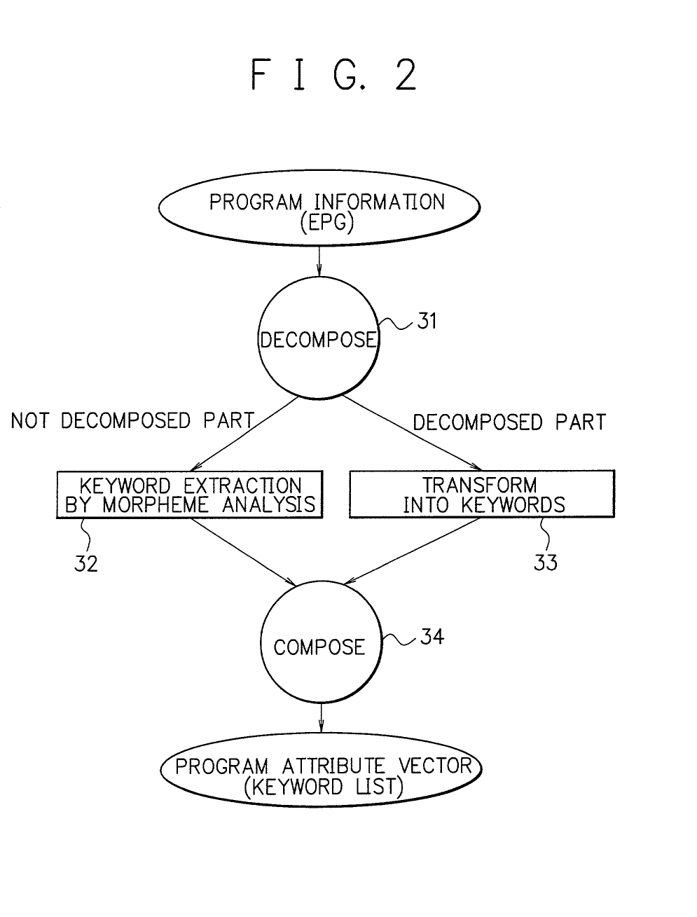

First, operation of the program information obtaining means 3 is explained in detail. FIG. 2 is a flowchart showing the operation of the program information obtaining means 3 at the embodiment of the broadcast program storing system of the present invention.

For example, a case, in which following text data are obtained as TV program information, is explained. The text data are as follows.

Broadcasting station and channel: XXX, B2;

Title: drama theater, poem of humanity, trial supervision for juveniles;

Genre: long play;

Broadcasting date: Dec. 12, 1998, Saturday;

Starting time and ending time: 21:00 and 22:15;

Staff: written by M. Yajima, directed by T. yoshinaga;

Cast: A . . . R. Kamikawa, B . . . Y. Asou, C . . . T. Yamashita, . . . ;

Outline: a supervisor Hirokawa (R. Kamikawa) of a branch of a family court started to suppose that a boy Shinya (T. Yamashita) stood up for someone, while Hirokawa was interviewing Shinya who had killed his father.

In this text data, the part of the broadcasting date, the channel, the starting time, the ending time, the staff, and the casts is not necessary to be decomposed to extract necessary attributes, and are already decomposed. However, the part of the title and the outline is a necessary part to be decomposed.

Referring to FIG. 2, this operation is explained. At the program information obtaining means 3, first, the program information (electronic program guide (EPG)) is decomposed into a decomposed part and a not decomposed part (step 31). And keywords are extracted from the not decomposed part by applying a morpheme analysis, and a keyword list of the not decomposed part is formed (step 32). For example, at the case that nouns are used as keywords, XXX, play, theater, humanity, juveniles, supervision, family court, branch, supervisor, Hirokawa, R. Kamikawa, father, Shinya, T. Yamashita, interview, and someone, are obtained as keywords from the title and the outline. At the decomposed part, the name of a person is used as a keyword as it is, and the others are transformed into keywords expressing their attributes, and a keyword list of the decomposed part is formed (step 33).

For example, at the text data mentioned above, the broadcasting date, the channel, the starting time, the ending time, the genre, the casts are transformed into as follows with some broader meaning.

The broadcasting date is Saturday, the channel is XXX, B2, the starting time is 20:00-22:00, the length of the program is 60-90, the genre is play, and M. Yajima, T. Yoshinaga, R. Kamikawa, Y. Asou, T. Yamashita are as they are.

Overlapped keywords in the keyword lists of the not decomposed part and the decomposed part are examined and removed under that each one of the overlapped keywords is kept, and after this, the both keyword lists are composed (step 34), and one keyword list (program attribute vector) is formed.

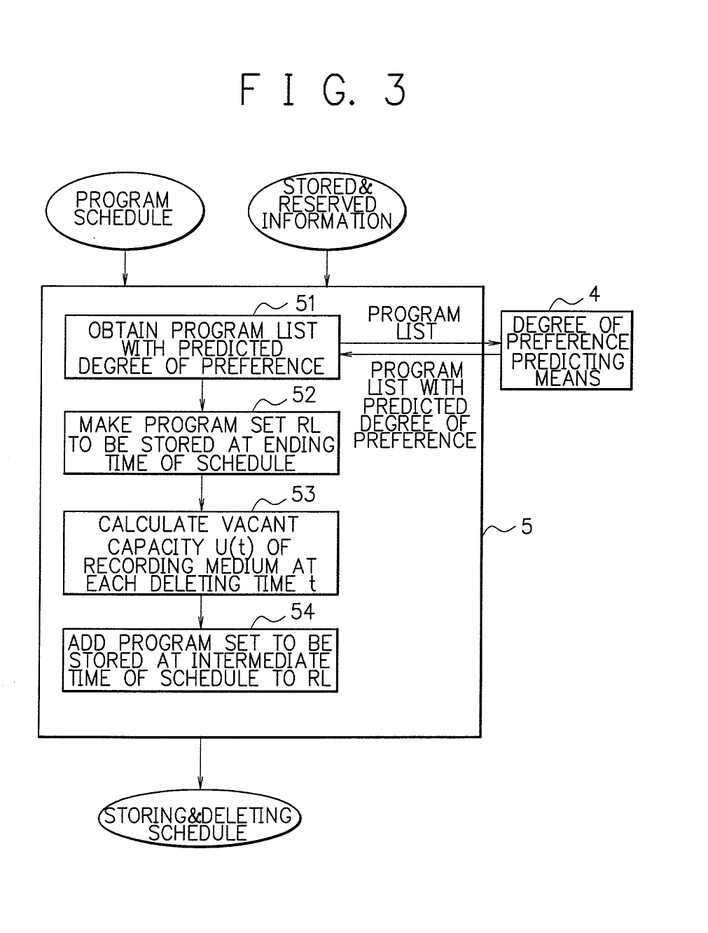

FIG. 3 is a flowchart showing operation of the storing planning means 5 at the embodiment of the broadcast program storing system of the present invention. Referring to FIG. 3, the operation of the storing planning means 5 is explained. First, the storing planning means 5 makes a program list by using a future program schedule from the program schedule storage 15, and the stored and reserved information from the storing control information storage 12, and gives the program list to the degree of preference predicting means 4. The degree of preference predicting means 4 calculates the degree of preference for each of the programs in the program list, and returns the calculated results (program list with predicted degree of preference) to the storing planning means 5 (step 51). The storing planning means 5 makes a program set RL to be stored at the ending time of the schedule based on the obtained program list with the predicted degree of preference (step 52). In this, elements of the program set RL is a combination (k, t) of a program k and a time t when the program k is deleted. After this, vacant capacity U (t) of the recording medium at each deleting time t in the program set RL is calculated (step 53). And in order to make the vacant capacity U (t) zero at each deleting time t, a program set RL to be stored at the intermediate time is added to the original program set RL (step 54), and the added program set RL is stored in the storing control information storage 12 as the storing and deleting schedule.

The storing and deleting schedule obtained from the added program set RL outputting from the storing planning means 5 is made to be that the predicted degree of satisfaction is as large as possible. In this, the predicted degree of satisfaction is defined as follows. At the case that one program k was stored and the program k was deleted at the time t, the predicted degree of satisfaction is defined as V (k, t). When the predicted degree of preference of the program k is defined as pₖ, the length of the program k is defined as lₖ, and the ending time of the program k is defined as eₖ, the predicted degree of satisfaction V (k, t) is expressed in the following equations, that is, V₁ (k, t), V₂ (k, t), and V₃ (k, t).

V₁(k, t)=pₖ (1)

V₂ (k, t)=pₖ·lₖ (2)

V₃ (k, t)=pₖ·lₖ·(t−eₖ) (3)

In this, the V₁ (k, t) signifies that the predicted degree of preference pₖ is used as the predicted degree of satisfaction as it is. The V₂ (k, t) signifies that the predicted degree of preference pₖ is multiplied by the length of the program lₖ, at the case that the predicted degree of preference is the viewing probability, the V₂ (k, t) signifies the expected viewing time. And the V₃ (k, t) signifies that the V₂ (k, t) is further multiplied by a survival time being time from the ending of the program until the deletion of the program. And at the case that the predicted degree of preference is the viewing probability and the distribution of the viewing time of the user is a uniform distribution, the V₃ (k, t) signifies that the integration of expected viewing time at each time.

Elements of the storing and deleting schedule of the program set RL consist of the combination (k, t) of the program k and the deleting time t of the program k, and the predicted degree of satisfaction of the storing and deleting schedule of the program set RL is calculated in a following equation (4).

$${\sum }_{( k , t ) ∈ RL} V ( k , t ) \qquad ( 4 )$$

In this, the capacity of the recording medium has a bound, therefore the storing and deleting schedule of the program set RL must be planned by considering this bound, and this is denoted by a following equation (5). In this, the capacity of the recording medium is defined as that a program of r minutes can be stored, and a program set being stored in the recording medium at the time s based on the storing and deleting schedule of the program set RL is defined as RL^{s}. That is, the RL^{s} is denoted as the equation (5).

RL^{s}{k:(k, t)εRL, bₖ≦s<t} (5)

In this, the bₖ denotes the starting time of the program k.

At this time, the capacity bound of the recording medium is expressed in an equation (6) at all the time s.

$${\sum }_{k ∈ {RL}^{s}} {l}_{k} \leq r \qquad ( 6 )$$

At this capacity bound (6) of the recording medium, a problem, by which the predicted degree of satisfaction given by the (4) is made to be maximal, is named as a temporally expanded knapsack problem. This temporally expanded knapsack problem is a problem that the normal knapsack problem is expanded so that a time element is included, and the optimal solution can not be obtained by using a dynamic programming, but the normal knapsack problem can do, and an efficient solving method is not known. The knapsack problem and its solving method by using the dynamic programming is described in the book, Discrete Optimization Method and Algorithm, Applied Mathematics, published by Iwanami Shoten, Publishers, written by T. Ibaraki, 1993, pp. 81-82.

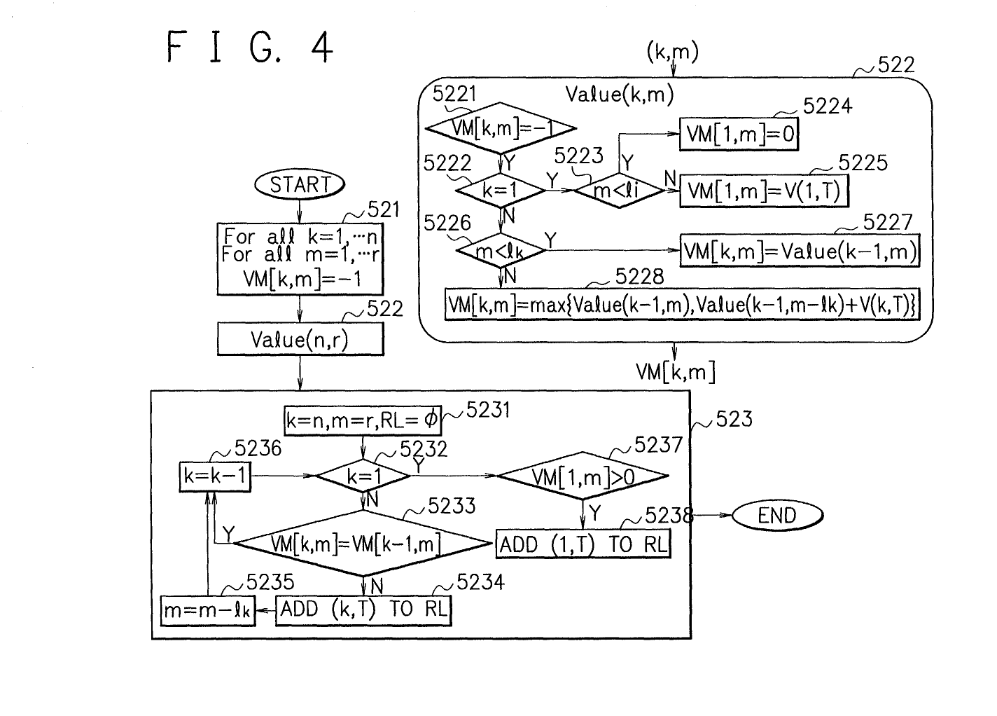

Therefore, at the embodiment of the present invention, at the operation to make the storing and deleting schedule of the program set RL, first, at the step 52, a program set RL to be stored at the ending time of the planned schedule is made and fixed. And further, at the step 54, a program set RL to be stored at the intermediate time of the planned schedule is made and added the original program set RL. That is, in order to make the final storing and deleting schedule of the program set RL, a method having two steps is applied. This two-step method is named as the temporally expanded knapsack problem. At making the program set RL to be stored at the ending time, the normal knapsack problem can be applied and the optimal solution can be obtained by the dynamic programming, this operation is shown in FIG. 4. FIG. 4 is a flowchart showing operation of making the program set RL to be stored at the ending time (the step 52 in FIG. 3) by the dynamic programming at the storing planning means 5 at the embodiment of the present invention.

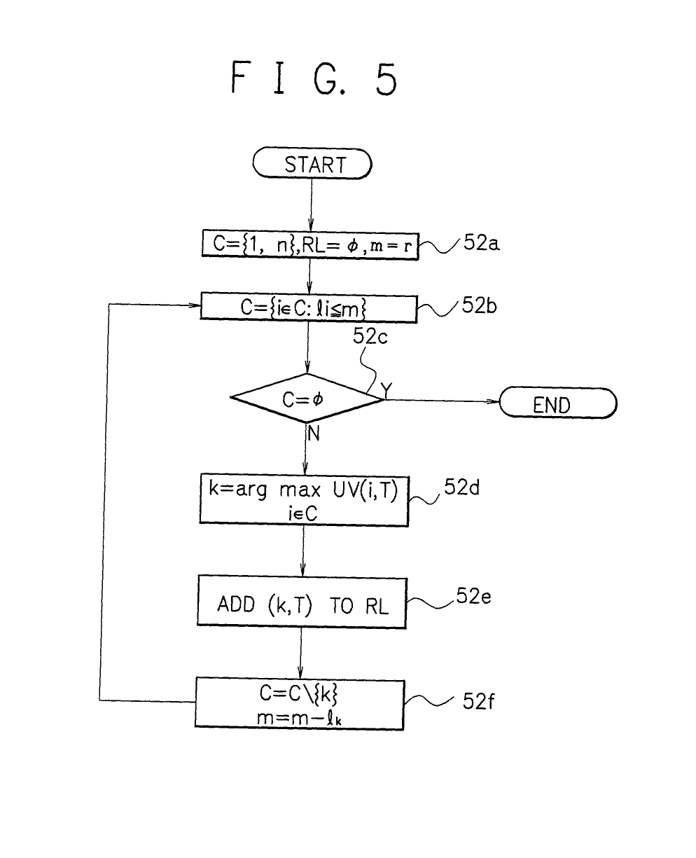

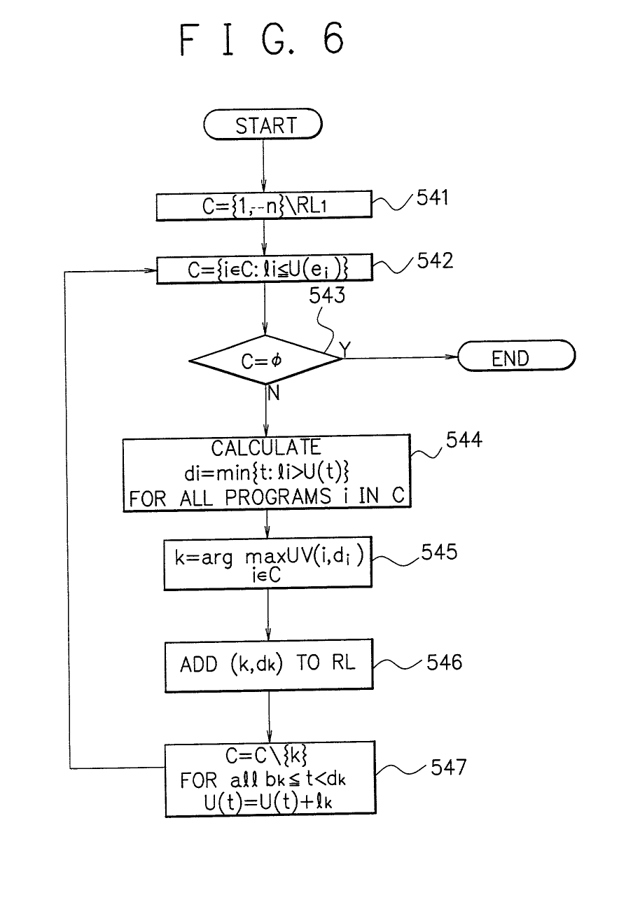

FIG. 5 is a flowchart showing operation of making the program set RL to be stored at the ending time (the step 52 in FIG. 3) by a greedy method as an approximate solution at the storing planning means 5 at the embodiment of the present invention. FIG. 6 is a flowchart showing operation of adding the additional program set RL to be stored at the intermediate time (the step 54 in FIG. 3) by the greedy method as an approximate solution at the storing planning means 5 at the embodiment of the present invention.

The program set RL being the program list at the ending time (the step 52 in FIG. 3) can be obtained by using the greedy method shown in FIG. 5 as an approximate solution, by choosing one from that the predicted degree of satisfaction per unit storing time (or unit storing time×survival time) is made to be maximal.

Referring to FIG. 4, it is explained that the program set RL being the program list at the ending time (the step 52 in FIG. 3) is made by using the dynamic programming. First, it is defined that programs are 1 . . . , n, and the storing available time calculated from the capacity of the recording medium is r minutes. And when the storing available time is only m minutes for the programs 1 to k, the value is defined as VM [k, m], at the case that a program set is chosen so that the sum of the value of the program set becomes maximal.

At step 522, a function Value (n, r) is called, and the VM [k, m] for (k, m), which is required to obtain the optimal solution at the case that the programs are 1 . . . , n and the storing available time is r minutes, is calculated. Before calculating the VM [k, m], as a preparation step, at step 521, for all the (k, m)ε{1, . . . , n}×{1 . . . , r}, the VM [k, m] is initialized to be −1. And step 523, a program set RL being a list of a combination of programs to be stored and a deleting time (designated time), in which the value of the VM [n, r] is realized from the two-dimensional array VM, is made.

Next, the function Value (n, r) being called at the step 522 is explained in more detail. The function Value (n, r) receives (k, m) as an input, and calculates the value of the VM [k, m] by a recursive call and sets the calculated value, and returns the value as a function value. First, when the value of the VM [k, m] has already been set for a given (k, m), the set value of the VM [k, m] is returned and the process ends (step 5221). And when the value of the VM [k, m] has not been set yet for the given (k, m), it is judged whether k=1 or not, and the process is changed by the judged result (step 5222).

At the case that the k=1, it is judged whether the program length l₁ of the program 1 is longer than the storing available time m minutes or not (step 5223). At the case that the judged result is YES (longer), the VM [1, m] is set to be 0 (step 5224). And at the case that the judged result is NO, a value V (1, T) of the case that the program 1 was deleted at the time T is set to the VM [1, m] (step 5225). And the value is returned as the function value and the process ends.

In this, the deleting time T is decided to be the longer enough time than the ending time of the programs 1, . . . , n, for example, 10 days later than the ending time. As the same as above, at the case that the k is not equal to 1, it is judged whether the program length lₖ of the program k is longer than the storing available time m minutes or not (step 5226). At the case that the judged result is YES (longer), the VM [k, m] is set to be Value (k−1,m) (step 5227). And at the case that the judged result is NO, the VM [k, m] is set to be a value that is not small in a Value (k−1, m) and a Value (k−1, m−lₖ)+V (k, T) (step 5228). And the value is returned as the function value, and the process ends. In this, the Value (k−1, m ) and the Value (k−1, m−lₖ) are calculated by the recursive call of the function Value (n, r).

Next, the step 523 is explained in detail. At this step 523, as mentioned above, a program set RL being a list of a combination of a programs to be stored and a deleting time, in which the value of the VM [n, r] is realized from the two-dimensional array VM, is made. First, a variable k signifying a program k under processing is set to be n, a variable m signifying a storing available minutes is set to be r, and the program set RL being a list is set to be an empty set (step 5231). Next, the following steps are repeated until the value of the k becomes 1 (step 5232).

First, it is examined whether the VM [k, m]=VM [k−1, m] (step 5233), at the case that the examined result is NO, the (k, T) is added to the program set RL being the list (step 5234), and the program length lₖ is subtracted from the storing available minutes m (step 5235). At the case that the examined result is YES, nothing happens, at both cases, the k is subtracted by 1 (step 5236). When the k became 1, it is examined whether the VM [1, m] is positive or not (step 5237), at the case of only YES, the (1, T) is added to the program set RL being the list (step 5238).

Referring to FIG. 5, the operation of approximately making the program set RL at the ending time (the step 52 in FIG. 3) by the greedy method at the storing planning means 5 at the embodiment of the present invention is explained. First, a program set being candidates to be stored is set in C, and a program set RL is set to be an empty set, and a variable m signifying remaining minutes for storing is set to be the storing available time r (step 52a). And programs whose program length is longer than the remaining minutes m are removed from the candidate set C (step 52b). And it is examined whether the C is an empty set or not (step 52c), and at the case of YES, the process ends. At the case of NO, a program i whose predicted degree of satisfaction is the highest per unit storing time (or unit storing time×survival time) in the candidate set C is searched, and the searched program i is set in a variable k being a program k (step 52d).

The predicted degree of satisfaction V (i, T) per unit storing time is that the predicted degree of satisfaction V (i, T), of the case that the program i is deleted at the time T, is divided by the program length lᵢ. And the predicted degree of satisfaction per unit storing time x survival time is that the predicted degree of satisfaction UV (i, T) per unit storing time is further divided by (T−bᵢ). In this, the bᵢ is the starting time of the program i. After this, (k, T) is added to the program set RL being the list (step 52e), and the program k is subtracted from the candidate set C and the program length lₖ is subtracted from the remaining storing minutes m (step 52f), and the step returns to the step 52b.

Referring to FIG. 6, the operation of adding the program set RL at the intermediate time to the program set RL at the ending time (the step 54 in FIG. 3) by the greedy method by using an approximate value at the storing planning means 5 at the embodiment of the present invention is explained. First, a program set belonging to the program set RL at the ending time is defined as RL₁, and a program set being candidate to be stored C is initialized to be a set {1, - - - , n}\RL₁ that the RL₁ is subtracted from all of the program set (step 541). Next, programs, in which U (eᵢ) being the remaining storing minutes at the ending time eᵢ of each of programs i is shorter than the program length lᵢ, are removed from the program set being candidate to be stored C (step 542). And it is examined whether the program set being candidate to be stored C is an empty set or not (step 543). At the case that the judged result is YES (empty set), the process ends. At the case that the examined result is NO (not empty set), a deleting time dᵢ of each of programs i belonging to the C is set to be the time when remaining storing minutes become smaller than the program length lᵢ (step 544).

Next, a program i whose predicted degree of satisfaction per unit storing time (or unit storing time×survival time) is the highest is searched in the C, and the searched program is set to be a variable k (step 545). The (k, dk) is added to the program set RL at the ending time (step 546), and the program k is removed from the C and the program length lₖ is subtracted from the remaining recording time U (t) at each time t that is longer than the starting time bk of the program k and shorter than deleting time t, and the process returns to the step 542 (step 547).

At the case that a program, which a user directly reserves to record, exists, a recording region, in which the program is stored, is vacant until the program starts. At the case of making the program set to be stored at the intermediate time, it can be planned to use the vacant region.

Actually, a combination of programs, which can not be reserved at the same time, exists, because of such as the limitation of the number of tuners. When the greedy method is applied, such limitation is checked at the step 52b, or the step 542, and only programs that satisfy this limitation are made to stay in the program set being candidate to be stored C. With this, a schedule that satisfies various limitations can be made.

When only programs having high the predicted degree of satisfaction are chosen, the same kinds of programs are chosen, and the degree of satisfaction of the user for the chosen programs may not be high. At the greedy method, at the calculation of the predicted degree of satisfaction per unit storing time UV (i, T), this problem can be solved by adding balance factors among genres. In order to know the balance factors among genres, the ratio of viewing minutes for each genre of the user is obtained by the statistics of the past viewing behavior of the user.

At the case that a program i of a genre A is added to the current program set RL being a storing list, when the sum of the program lengths of programs of the genre A in the program set RL being the storing list exceeds a value that the viewing ratio of the genre A of the user is multiplied by the storing capacity (minutes), by multiplying the value of the predicted degree of satisfaction UV (i, T) of the exceeded part by a discount ratio, a scheduling being close to the ratio of the viewing minutes of each genre can be made.

At the preference learning means 2 and the degree of preference predicting means 4, there are two learning/predicting methods. One is that the learning/predicting is implemented by a so-called content-based filtering method by using the program attribute vectors, and the other is that the learning/predicting is implemented by a social (or collaborative) filtering method by using the estimated degree of preferences of similar users. And there are a structure using either one of the methods and a structure using both of the methods. And at the structure using the both methods, there are further two methods. One is that a preference information server calculates the predicted degree of preference by using the social filtering method, and the other is that a home server calculates the predicted degree of preference by using both the content-based filtering method and social filtering method.

At the social filtering method, the predicted degree of preference of stored programs for a user is calculated by the viewing behavior of a similar user, such as “viewed for X X minutes”, “deleted before viewing”, “changed to permanent saving”, “inputted favorite/non-favorite”. And the predicted degree of preference of future programs for the user is calculated by the viewing behavior of the similar user, such as “reserved”, “inputted favorite/non-favorite”.

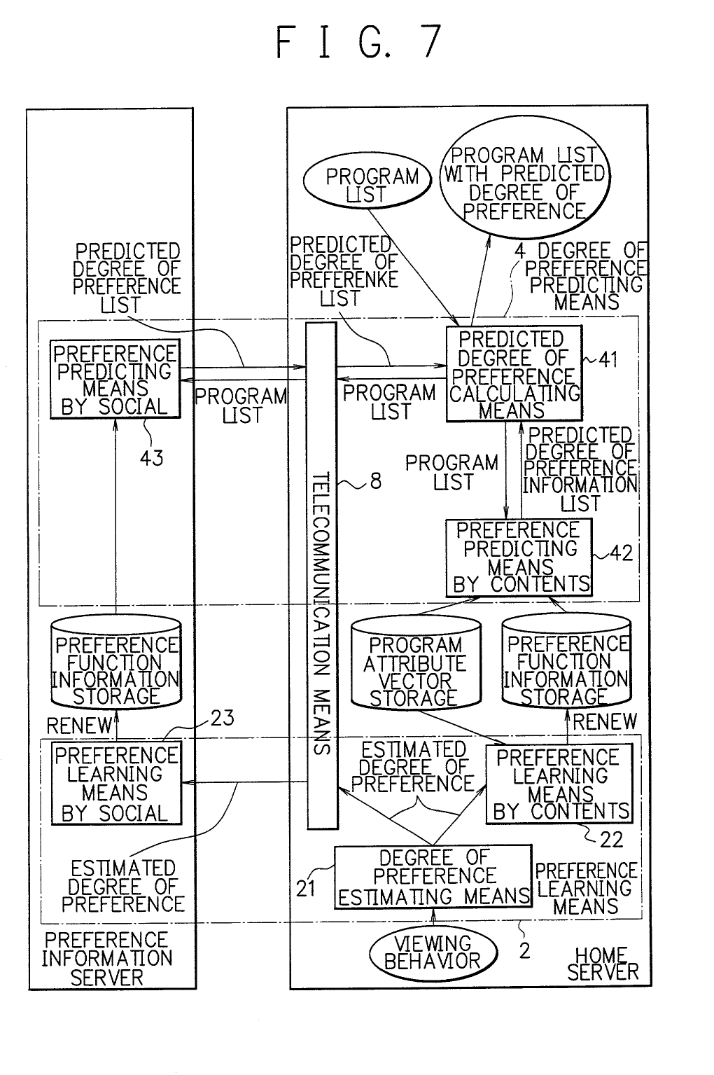

Next, referring to drawings, two structures using the both content-based and social filtering methods are explained. FIG. 7 is a block diagram showing a structure of the preference learning means 2 and the degree of preference predicting means 4 at the case that the predicted degree of preference is calculated at the preference information server by using the social filtering method at the embodiment of the present invention. The degree of preference predicting means 4 calculates the predicted degree of preference of programs belonging to the program list (stored program list and program list that will be broadcast until a certain time in the future) received from the storing planning means 5 and returns the calculated result to the storing planning means 5. In the degree of preference predicting means 4, the received program list is given to a preference predicting means by contents 42 and a preference predicting means by social 43 through a predicted degree of preference calculating means 41. In this, the preference predicting means by social 43 is in the preference information server that is connected to the home server through such as the Internet, therefore, the program list is given through a telecommunication means 8.

The preference predicting means by contents 42 obtains the program attribute vectors of the programs belonging to the program list from the program attribute vector storage (recording medium) and calculates the predicted degree of preference information from the program attribute vectors by using a function denoting by the preference function information stored in the preference function information storage (recording medium), and returns the calculated result to the predicted degree of preference calculating means 41. The preference predicting means by social 43 calculates the predicted degree of preference from the estimated degree of preference of the other user, already known for the programs to be predicted, by using the functions denoted by the preference function information stored in the storage, and returns the calculated result to the predicted degree of preference calculating means 41.

The predicted degree of preference calculating means 41 calculates a final predicted degree of preference by using the predicted degree of preferences returned from the preference predicting mean by contents 42 and the preference predicting mean by social 43, and returns the calculated result to the storing and planning means 5. In this, in order to obtain a final predicted degree of preference value by using two predicted degree of preference values by both contents and social, a weighted average of the two predicted values is made to be the final predicted value.

The preference learning means 2 learns preference functions by using information of the viewing behavior of the user obtained from the input and output means 1, and renews the preference function information. In the preference learning means 2, a degree of preference estimating means 21 estimates the degree of preference for the program by using the inputted viewing behavior. In this, the viewing behavior using for the estimation is such as “viewed for X X minutes”, “deleted before viewing”, “changed to permanent saving”, “inputted favorite/non-favorite” and “reserved recording”. In this, it is defined that the degree of preference is denoted by a real number from 0 to 1. The estimated degree of preference is given to a preference learning means by contents 22 and a preference learning means by social 23. In this, the preference learning means by social 23 is in the preference information server that is connected to the home server through such as the Internet, therefore, the estimated degree of preference is given through the telecommunication means 8.

The preference learning means by contents 22 learns preference functions by using the program attribute vectors of the programs to be learned obtained from the program attribute vector storage (recording medium) and the estimated degree of preference, and renews the preference function information. The preference learning means by social 23 also learns preference functions by using the estimated degree of preference, and renews the preference function information. Learning of weighting by both contents and social is implemented as follows. In this, a predicted degree of preference by contents is defined as pc, a predicted degree of preference by social is defined as ps, a final predicted degree of preference (average of the predicted degree of preference by contents and the predicted degree of preference by social) is defined as p, and an estimated degree of preference estimated by the viewing behavior is defined as r. With this, the learning of weighting is implemented by that the weight by contents is multiplied by rp_{c}/p+(1−r) (1−p_{c})/(1−p), and the weight by social is multiplied by rpₛ/p+(1−r) (1−pₛ)/(1−p). In this, the r is different from the r being the storing available minutes of the recording medium mentioned before.

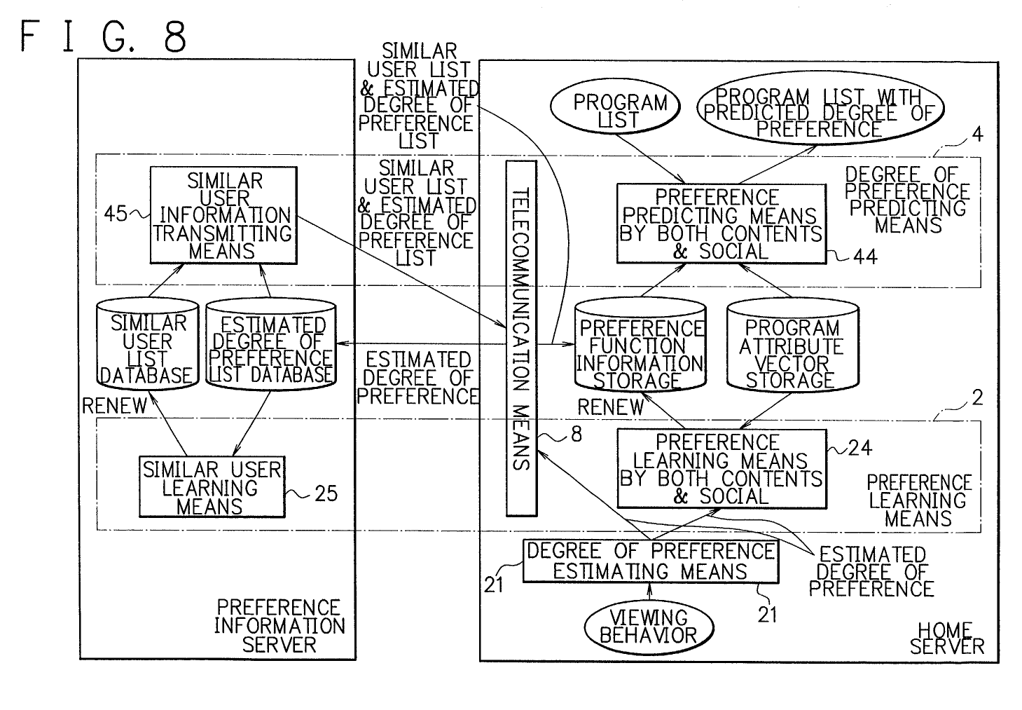

FIG. 8 is a block diagram showing a structure of the preference learning means 2 and the degree of preference predicting means 4 at the case that both of the predicted degree of preferences by contents and social are calculated at the home server at the embodiment of the present invention. In the degree of preference predicting means 4, a preference predicting means by both contents and social 44 calculates a predicted degree of preference list for a given program list and outputs the calculated result. At this time, the preference predicting means by both contents and social 44 uses a similar user list and an estimated degree of preference list for programs to be predicted of the similar users transmitted from a similar user information transmitting means 45, and the program attribute vectors.

In the preference learning means 2, the degree of preference estimating means 21 estimates the degree of preference of programs by using the inputted viewing behavior. The estimated degree of preference is given to a preference learning means by both contents and social 24 and is also stored in an estimated degree of preference database in the preference information server. The preference learning means by both contents and social 24 learns preference functions by using the program attribute vectors of programs to be learned obtained from the program attribute vector storage (recording medium), and the estimated degree of preference for the programs to be learned of the similar users and the estimated degree of preference of the user, and renews the preference function information. And at the preference information server, a similar user learning means 25 renews the similar user list for each user by using the estimated degree of preference stored in the estimated degree of preference database.

At the embodiment of the present invention, the prediction and learning are implemented by using a specialist model that handles both the predictions by contents and social together. This specialist model is described in a technical report written by Y. Freund et al., “Using and combining predictors that specialize”, in Proceedings of the Twenty-Ninth Annual ACM Symposium on Theory of Computing, 1997, pp. 334-343.

The specialist model is a model that implements a prediction based on predictions outputted from many prediction algorithms, and handles a case that the prediction is implemented by using weight appended to each of the algorithms. Especially, this specialist model handles a case, in which all of the prediction algorithms are not always output the prediction, this is different from an expert model in which all of the prediction algorithms always output predictions. At the case that the degree of preference of a user for a program is predicted, a set of specialists outputting predictions is defined as E, a predicted value of a specialist i belonging to the set E is defined as qᵢ, and the current weight is defined as wᵢ. At this time, the predicted value p based on the prediction of the specialist is expressed in an equation (7). In this, the i is different from the program i mentioned before.

$$p = \frac{{\sum }_{i ∈ E} {w}_{i} {q}_{i}}{{\sum }_{i ∈ E} {w}_{i}} \qquad ( 7 )$$

At the embodiment of the present invention, in order that programs whose reliability of the predicted degree of preference is low are not chosen as large as possible, for reflecting so-called exploration-exploitation trade-off, a correction that λ (constant value) times of weighted average standard deviation d are added to the predicted value p calculated by the equation (7). In this, the weighted average standard deviation d is calculated by the following equation (8).

$$d = \sqrt{\frac{{\sum }_{i ∈ Ei} {wi ( {q}_{i} - p )}^{2}}{{\sum }_{i ∈ E} wi}} \qquad ( 8 )$$

And at the learning, at the case that the actual degree of preference r is 0≦r≦1, the weight wi of the specialist i belonging to the specialist set E is renewed by a following equation (9).

$${w}_{i} = {w}_{i} \{ \frac{{rq}_{i}}{p} + \frac{( 1 + r ) ( 1 - {q}_{i} )}{1 - p} \} \qquad ( 9 )$$

At the present invention, at the preference prediction and learning means by contents, a specialist is set for each keyword in the program attribute vector. And each specialist predicts only for a program having an attribute vector including a corresponding keyword. The predicted value is such as a value of RIN or a value of (R+0.5)/(N+1.0), in this, the number of programs having attribute vectors including the keyword at the past is N, and the sum of the evaluation value (0 to 1 ) of the programs is R.

At the preference prediction and learning means by social, a specialist is set for each similar user for each user. And each specialist predicts only at the case that the estimated evaluation value for the program of the corresponding similar user is already known. And the predicted value is the estimated evaluation value.

As mentioned above, according to the broadcast program storing system of the present invention, favorite programs for a user are automatically stored in a recording medium based on his/her preferences. Further, some favorite programs, which the user does not recognize, for the user are automatically stored in the recording medium by predicting from the preferences of similar users and the program information. Moreover, the recording medium is always utilized efficiently, and a combination of programs whose degree of satisfaction of the user is high can be always kept in the recording medium fully.

While the present invention has been described with reference to the particular illustrative embodiment, it is not to be restricted by that embodiment but only by the appended claims. It is to be appreciated that those skilled in the art can change or modify the embodiment without departing from the scope and spirit of the present invention.

What is claimed is:

1. A broadcast program storing system, comprising:
a preference learning means for learning preferences of a user for programs by viewing behavior of said user;
a degree of preference predicting means for predicting the degree of preference of said user for said programs by obtaining program information; and
a storing planing means for choosing programs by solving a temporally expanded knapsack problem that obtains a solution in which the sum of predicted degree of satisfaction of said user in a planned schedule becomes maximal within a bound of a recording medium, when programs to be stored and programs to be deleted are decided.

2. A broadcast program storing system in accordance with claim 1, wherein:
said storing planning means makes a storing plan of programs in the future and also makes a plan of the deleting time of stored programs at the same time.

3. A broadcast program storing system in accordance with claim 2, wherein:
said storing planning means makes said storing plan of said programs by utilizing efficiently a region of said recording medium where a program that said user reserves to record is recorded until right before said program starts.

4. A broadcast program storing system in accordance with claim 2, wherein:
said storing planning means makes said storing plan of said programs by using a two-step-method in which first a program set to be stored at the ending time of said planned schedule is obtained and a program set to be stored at the intermediate time of said planned schedule for storing in the remaining vacant region of said recording medium is added.

5. A broadcast program storing system in accordance with claim 4, wherein:
when said storing planning means makes said storing plan of said programs by using said two-step-method,
said program set to be stored at the ending time of said planned schedule is obtained by a dynamic programming in which a solution that makes the sum of said predicted degree of satisfaction of said user maximal is obtained.

6. A broadcast program storing system in accordance with claim 4, wherein:
when said storing planning means makes said storing plan of said programs by using said two-step-method,
said program set to be stored at the ending time of said planned schedule is obtained by a greedy method in which a quasioptimal solution of said predicted degree of satisfaction of said user is obtained by choosing a larger predicted degree of satisfaction in a predicted degree of satisfaction by unit storing time and a predicted degree of satisfaction by unit storing time×survival time.

7. A broadcast program storing system in accordance with claim 4, wherein:
when said storing planning means makes said storing plan of said programs by using said two-step-method,
said program set to be stored at the intermediate time of said planned schedule for storing in the remaining vacant region of said recording medium is added by said greedy method in which a quasioptimal solution of said predicted degree of satisfaction of said user is obtained by choosing a larger predicted degree of satisfaction in a predicted degree of satisfaction by unit storing time and a predicted degree of satisfaction by unit storing time×survival time.

8. A broadcast program storing system in accordance with claim 6, wherein:
when said storing planning means uses said greedy method,
said storing plan is made by not only considering the largeness of said predicted degree of satisfaction but also checking whether elements required to record such as tuners are secured or not.

9. A broadcast program storing system in accordance with claim 7, wherein:
when said storing planning means uses said greedy method,
said storing plan is made by not only considering the largeness of said predicted degree of satisfaction but also checking whether elements required to record such as tuners are secured or not.

10. A broadcast program storing system in accordance with claim 6, wherein:
when said storing planning means uses said greedy method,
said storing plan is made by that a ratio among viewing minutes of each genre of programs of said user is obtained by the statistics of the past viewing behavior of said user, and a discount rate for part exceeding from said viewing minute ratio of each genre is calculated and the balance among said genres is kept, when the degree of satisfaction at the time that the programs to be stored are chosen one by one is calculated.

11. A broadcast program storing system in accordance with claim 7, wherein:
when said storing planning means uses said greedy method,
said storing plan is made by that a ratio among viewing minutes of each genre of programs of said user is obtained by the statistics of the past viewing behavior of said user, and a discount rate for part exceeding from said viewing minute ratio of each genre is calculated and the balance among said genres is kept, when the degree of satisfaction at the time that the programs to be stored are chosen one by one is calculated.

12. A broadcast program storing system in accordance with claim 5, wherein:
said predicted degree of satisfaction is a predicted degree of preference, or said predicted degree of preference×a program length, or said predicted degree of preference×said program length×survival time.

13. A broadcast program storing system in accordance with claim 6, wherein:
said predicted degree of satisfaction is a predicted degree of preference, or said predicted degree of preference×a program length, or said predicted degree of preference×said program length×survival time.

14. A broadcast program storing system in accordance with claim 7, wherein:
said predicted degree of satisfaction is a predicted degree of preference, or said predicted degree of preference×a program length, or said predicted degree of preference×said program length×survival time.

15. A broadcast program storing system in accordance with claim 1, wherein:
said degree of preference predicting means and said preference learning means, comprising:
a system, wherein:
an electronic text being program information received from broadcasting or telecommunication is transformed into an attribute vector consisting of keywords;
a preference function expressing a relation between an estimated degree of preference estimated from viewing behavior of a user and said attribute vector is learned;
a preference function value of said attribute vector is made to be a predicted degree of preference for a program to be stored;
a virtual specialist that predicts only when a keyword is in said attribute vector for every program, and weighting of said virtual specialist are set;
said prediction is implemented by a weighted average prediction of said virtual specialist; and
learning is implemented by adjusting said weighting,
at said system,
as a predicted value of said virtual specialist corresponding to each keyword, an average value of said estimated degree of preferences of programs having said attribute vector including the keyword, or a Laplace estimation value (accumulated estimated degree of preference+0.5)/(number of appearances+1.0) of said estimated degree of preferences is used; and
learning is implemented by that weighting of said virtual specialist of the estimated degree of preference q is multiplied by rq/p+(1−r) (1−q)/(1−p), in this, p is a predicted weighted average of said virtual specialist and r is an estimated degree of preference from actual viewing behavior of said user.

16. A broadcast program storing system in accordance with claim 1, wherein:
at said degree of preference predicting means and said preference learning means, a system is used, and
said system, comprising:
a preference information server via a telecommunication means, wherein:
similarity of preferences among users is learned by the estimated degree of preferences of past programs transmitted via said telecommunication means; and
a degree of preference of a user to be predicted for a future program to be stored by said user is estimated by using the estimated degree of preferences of said users for programs transmitted already and said similarity between said user to be predicted and said users,
at said system,
a virtual specialist and weighting that implement a prediction, only when the estimated degree of preferences of similar users for every similar user of each user is known, are set,
prediction is implemented by the weighted average of the prediction of said virtual specialist,
learning is implemented by adjusting said weighting,
the estimated degree of preference of said similar user is used as the predicted value of said virtual specialist corresponding to each similar user, and
learning is implemented by that the weighting of said virtual specialist of the estimated degree of preference q is multiplied by rq/p+(1−r) (1−q)/(1−p), in this, p is a predicted weighted average of said virtual specialist and r is an estimated degree of preference from actual viewing behavior of said user.

17. A broadcast program storing system in accordance with claim 1, wherein:
both of said virtual specialist claimed 15 and said virtual specialist claimed 16 are used, and said prediction is implemented by the weighted average of said two specialists, and
learning is implemented by that weighting of said claim 15 is multiplied by rp_{c}/p+(1−r) (1−p_{c})/(1−p), and weighting of said claim 16 is multiplied by rpₛ/p+(1−r) (1−pₛ)/(1−p), in this, a predicted degree of preference by said claim 15 is defined as pc, a predicted degree of preference by said claim 16 is defined as ps, a final predicted degree of preference (average of the predicted degree of preference by both said claims 15 and 16) is defined as p, and an estimated degree of preference estimated by said viewing behavior is defined as r.

18. A broadcast program storing system in accordance with claim 1, wherein:
both of said virtual specialist claimed 15 and said virtual specialist claimed 16 are used, and said prediction is implemented by the weighted average of said two specialist, and
learning is implemented by using the weighted average of all of said virtual specialists instead of predicted weighted average p of said claims 15 and 16.

19. A broadcast program storing system in accordance with claim 1, wherein:
at said degree of preference predicting means, the weighted average of standard deviation of said predicted degree of preference of each virtual specialist is regarded as being uncertainty, and final predicted degree of preference is that constant times of said uncertainty is added to said predicted weighted average of said virtual specialists.

20. A broadcast program storing system in accordance with claim 1, further comprising:
recompressing means for recompressing stored data of said programs stored once.

21. A broadcast program storing system in accordance with claim 1, further comprising:
compression rate designating means for designating a compression rate for each program when each program is stored.
